(19) United States
(12) Patent Application Publication
(10) Pub. No.: US 2022/0204896 A1
(43) Pub. Date: Jun. 30, 2022

(54) METHOD OF PRODUCING A SPIRIT BASED ON AN IN-BOTTLE ENHANCEMENT REQUEST

(71) Applicant: James Joseph Sanctified Spirits, LLC, Westlake, TX (US)

(72) Inventor: Joseph Giildenzopf, Westlake, TX (US)

(21) Appl. No.: 17/566,506

(22) Filed: Dec. 30, 2021

Related U.S. Application Data
(60) Provisional application No. 63/132,648, filed on Dec. 31, 2020.

(51) Int. Cl. C12G 3/06; B67D 1/08; B67D 1/00

(52) U.S. Cl. CPC C12G 3/06; B67D 1/0041; B67D 1/0021; B67D 1/0888

(57) ABSTRACT

The disclosure provides a method of producing an enhanced spirit that uses an in-bottle enhancement request (IBER) as a basis for enhancing the flavor of the spirit. As such, other parties instead of spirit manufacturers can direct the production of an enhanced spirit according to flavor profiles of their choosing. In addition to a method, the disclosure also provides a computing system for receiving and processing an IBER, and a computer program product that automatically generates an order for an enhanced spirit based on an IBER. In one example, the method includes: (1) receiving an IBER, (2) placing at least one spirit in a bottle based on the IBER, (3) placing one or more products in the bottle based on the IBER, and (4) sealing the bottle, having located within the bottle both the at least one spirit and the one or more products.

### CROSS-REFERENCE TO RELATED APPLICATION

This application claims the benefit of U.S. Provisional Application Ser. No. 63/132,648, filed by Joseph Giildenzopf on Dec. 31, 2020, entitled “A METHOD OF PRODUCING A SPIRIT BASED ON AN IN-BOTTLE ENHANCEMENT REQUEST,” commonly assigned with this application and incorporated herein by reference in its entirety.

### TECHNICAL FIELD

This application is directed, in general, to producing spirits and, more specifically, to enhancing a flavor of a spirit.

### BACKGROUND

A distilled spirit, also referred to as a distilled beverage, liquor, hard liquor or hard alcohol, is an alcoholic beverage produced by distillation of fermented grains, fruit, or vegetables. Some distilled spirits, such as whiskey, bourbon, scotch, and rum, are aged after distillation. Aging is a process of storing the distilled spirits in wood barrels for an amount of time to add distinct flavors and remove harsh flavors from the raw alcohol. The wood barrels are typically constructed of toasted wood that interacts with the distilled spirit to contribute organic compounds and transforms acids into esters to give spirits their unique flavor.

The distilled spirit obtains distinct flavors from the different types of wood that are used for the barrels. In addition to distinct flavors, aging also adds color to the clear distilled spirits. The amount of time and the type of wood barrels can be specified for some distilled spirits. For example, all Scotch whisky must be aged in oak barrels for at least three years.

Once a distilled spirit is aged, it is typically removed from the wood barrel and bottled for distribution or later consumption. In contrast to wines, distilled spirits do not improve with age once removed from the wood barrels and placed in bottles. Instead, the maturation of the distilled spirit ends when removed from the wood barrels and the taste of the unopened whiskey, rum, etc. will not change while bottled and waiting to be purchased.

### SUMMARY

In one aspect, a method of manufacturing an enhanced spirit is disclosed. In one example, the method includes: (1) receiving an in-bottle enhancement request (IBER), (2) placing at least one spirit in a bottle based on the IBER, (3) placing one or more products in the bottle based on the IBER, and (4) sealing the bottle, having located within the bottle both the at least one spirit and the one or more products.

In another aspect, a computing system for receiving and processing an IBER for an enhanced spirit is disclosed. In one example the computing system comprising one or more processors to perform one or more operations including: (1) receiving an IBER, (2) determining one or more enhancers for a spirit based on the IBER, and (3) automatically generating an order for one of more bottles of an enhanced spirit using the one or more enhancers.

In yet another aspect, a computer program product is disclosed. In one example the computer program product has a series of operating instructions stored on a non-transitory computer-readable medium that directs one or more processors when executed thereby to perform operations to generate an order for an enhanced spirit, the operations comprising: (1) receiving an IBER, (2) determining one or more enhancers for a spirit based on the IBER, and (3) automatically generating an order for one of more bottles of an enhanced spirit using the one or more enhancers.

### BRIEF DESCRIPTION

Reference is now made to the following descriptions taken in conjunction with the accompanying drawings, in which:

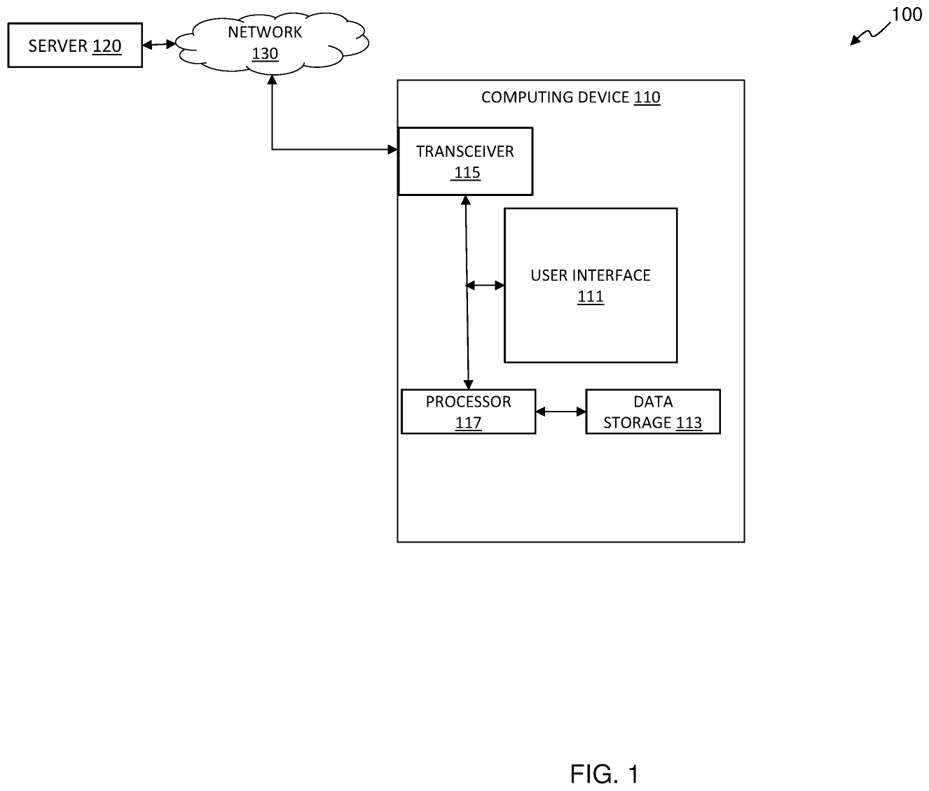

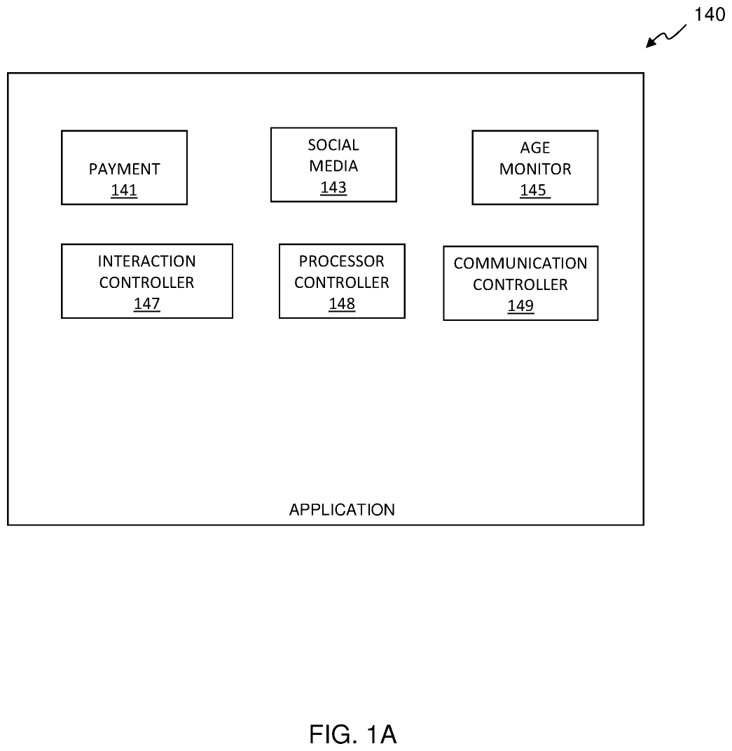

FIG. 1 illustrates a block diagram of an example of a computing system configured to receive and process an IBER according to the principles of the disclosure;

FIG. 1A illustrates a block diagram of an example of an application providing functions according to the principles of the disclosure;

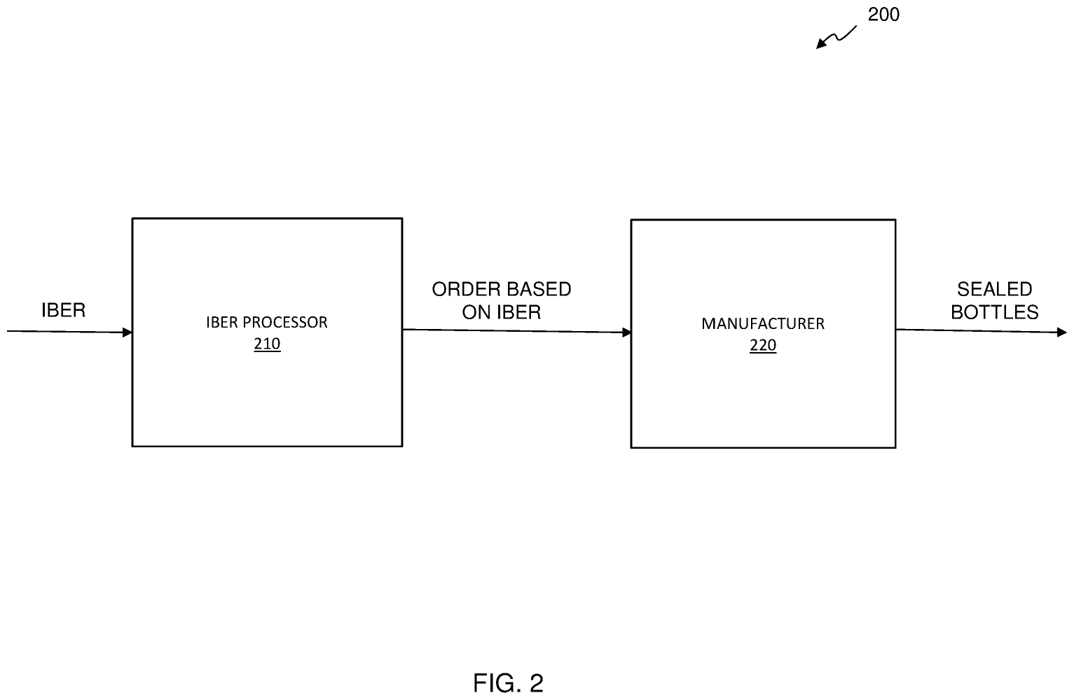

FIG. 2 illustrates a block diagram showing an example of a manufacturing system constructed according to the principles of the disclosure;

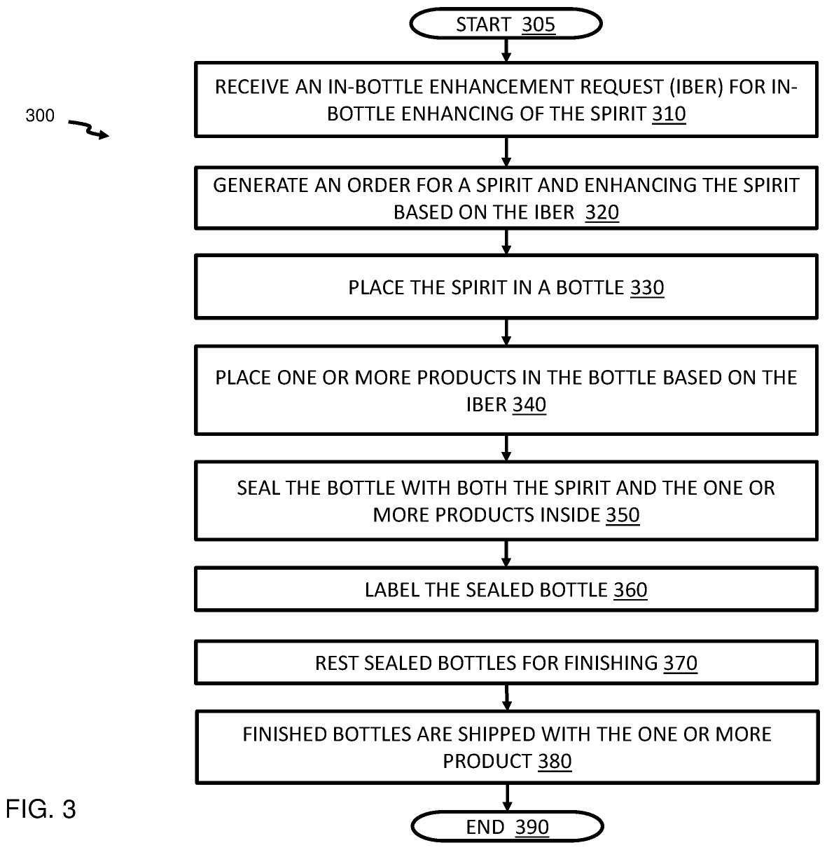

FIG. 3 illustrates a flow diagram of an example of a method of producing an enhanced spirit based on an IBER;

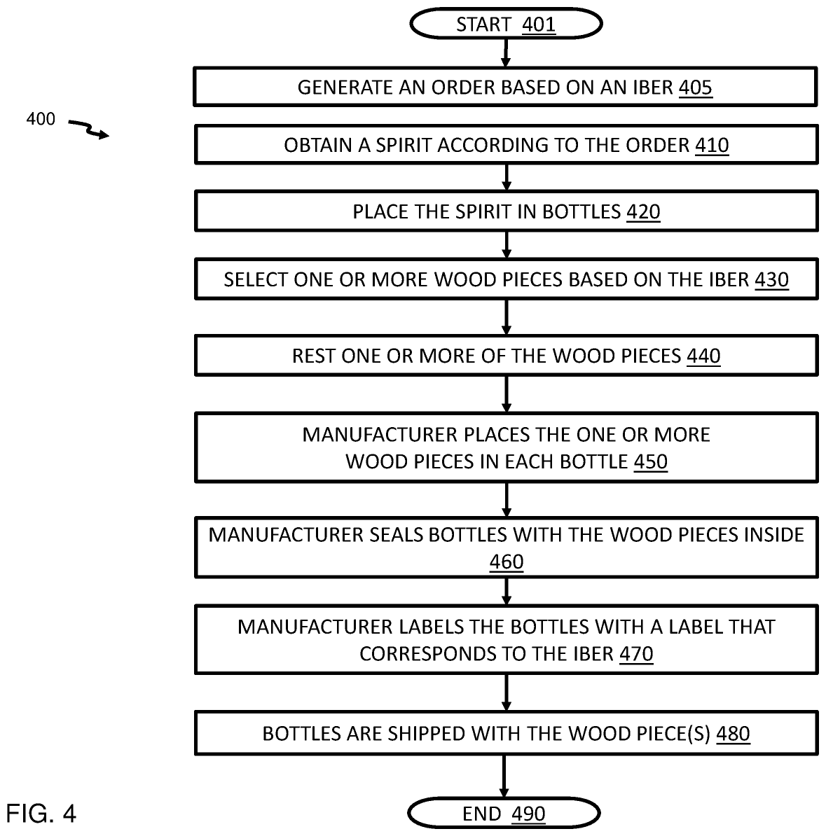

FIG. 4 illustrates a flow diagram of another example of a method of producing an enhanced spirit based on an IBER; and

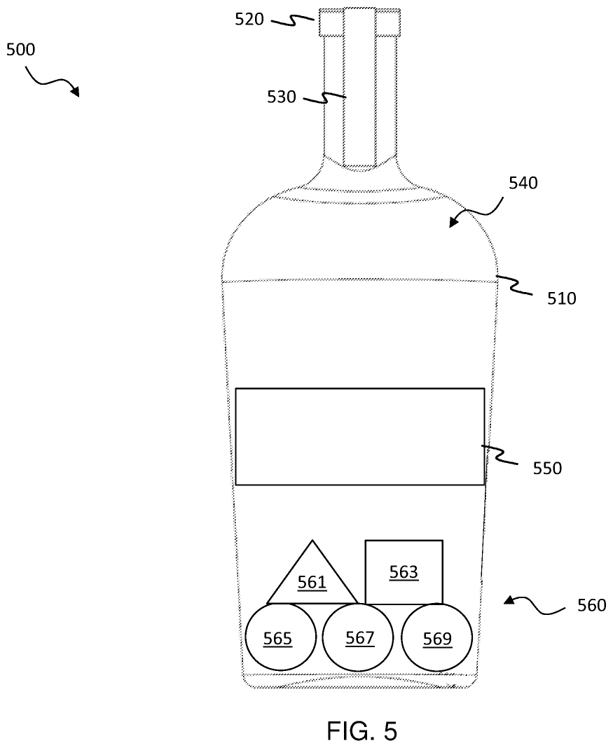

FIG. 5 illustrates an example of a bottle of spirit having wood pieces for enhancing according to an IBER.

### DETAILED DESCRIPTION

Before being bottled, an additional processing step is sometimes used to add additional flavor to aged distilled spirits. This step, referred to as finishing, is a technique whereby aged spirits are placed in a secondary barrel or cask for further maturation. The secondary cask has most likely been used previously to age another spirit, like rum, brandy, wine, or beer. A finished spirit is sometimes referred to as double-matured since the spirit is matured in a first cask (aging) and then matured in another cask (a second cask for finishing) of a different origin.

By placing the aged spirit in a secondary cask the spirit takes on new, more nuanced flavors from the wood and other elements that are inherent to the secondary cask. This “finishes” the spirit and makes it unique (sanctified). Unfortunately, finishing requires more time in addition to the time used for aging. As such, the cost and time for finishing can outweigh the benefit of a finished spirit. This can have a chilling effect on the development and delivery of new products to the market.

Another restriction to the development and delivery of new products is the reliance on the manufacturers or producers of the spirits (collectively referred to as manufacturers) to produce new flavor profiles or enhancements for spirits. By restricting the selection of enhancements to the manufacturers, other parties, such as consumers, are denied the opportunity to have a spirit manufactured according to their desired flavor profile. Additionally, other parties are denied the opportunity to try these enhanced spirits that are produced according to the desired flavor profiles of others.

The disclosure provides a method of producing an enhanced spirit that uses an in-bottle enhancement request (IBER) as a basis for enhancing the flavor of the spirit. The IBER is a request from a party to a manufacturer or representative of a manufacturer to produce an enhanced spirit according to a flavor profile, e.g., a spirit enhanced by an enhancer such as one or more wood piece. A representative is a person or persons of a business entity that is affiliated with one or more spirit manufacturers. For example, a tasting room can be independent of a specific spirit manufacturer but a representative of that spirit manufacturer and one or more other spirit manufacturers. The party is an entity or person other than the manufacturer. The flavor profile can be represented in the IBER by identifying one or more products or a combination of one or more products and one or more resting agents for enhancing the flavor of a bottled spirit. For example, the products, resting agents, etc., can be selected from the IBER. The flavor profile can also be described and the manufacturer can select products, resting agents, and a combination thereof to enhance a bottled spirit according to the flavor profile to create an enhanced spirit. For example, the in-bottle enhancement can include a flavor profile of sweet, toasted oak, and the manufacture can select one or more products or a combination of one or more product and one or more resting agent to achieve the flavor profile. The IBER can also include a specific type of spirit to place in the bottle. Otherwise, the IBER can include the flavor profile and allow the manufacturer to select the spirit to enhance. The IBER can include several different spirits to enhance with a single flavor profile.

The IBER can also include the number of bottles to be manufactured using the flavor profile. The one or more products from the IBER is placed in each of the bottles with at least one spirit during manufacturing before the bottle is sealed for commercial sale and distribution. Sealing as used herein refers to capping and sealing a spirit in a bottle (such as a glass bottle) for commercial sale. Sealing can be performed according to industry standards and via a conventional method including, but not limited to, cork type closures, capsules (including spinning and shrinking), and screw-on caps. Once sealed, the seal is broken and the lid is removed by the purchaser/consumer of the bottled spirit.

The one or more products from the IBER can include at least one wood piece. Another type of product can also be used to add a flavor, such as a spice (e.g., cinnamon stick), a pepper, or a honeycomb. A combination of the different products can be used, such as a wood piece and a spice.

Considering a wood piece, the at least one wood piece is used for further maturation or enhancing of the spirit in the bottle. For example, a wood piece can be used for finishing of an aged distilled spirit that is in the bottle. Thus, instead of in-cask finishing, the disclosed method advantageously employs in-bottle finishing according to the IBER. The wood piece is produced to increase the interaction of the wood with the spirit in the bottle. As such, the amount of time for finishing of an aged distilled spirit compared to in-cask finishing can be reduced. Since part of the manufacturing process of the spirit can include using at least one wood piece, consistency of the wood pieces that are employed for finishing is needed. Accordingly, the wood pieces are produced according to certain parameters to produce a consistent finish across multiple bottles; including bottles having different volumes. The IBER can include an amount of time for resting the one or more wood pieces in one or more resting agents. A different amount of time can be used for resting different pieces of wood.

The IBER can identify the type of wood piece or pieces to be used. The wood pieces can be cut to provide a high ratio of wood surface area to the spirit in a bottle. The wood pieces can be cut to provide an orientation of the wood grain to wood surface for an optimal wood-to-spirit in-bottle interaction. Accordingly, the surface area and grain orientation of the wood piece can be designed to reduce finishing time compared to using a secondary cask. The wood pieces can be wood spires having a high surface area for chemical reaction with the spirit. The design and production of the wood pieces allow the wood to impart desired chemical constituents into the bottled spirit while reacting and removing other chemical constituents (e.g., undesirable chemical constituents) from the bottled spirit in accordance with a known volume of the bottle and time used for enhancing.

The wood pieces can also have other shapes, such as spheres, cones, cylinders, or a type of polyhedron. A non-limiting list of different type of polyhedrons that can be used include cubes, pyramids, octahedron, dodecahedron, and icosahedron. Polygons having a higher number of faces, for example an icosahedron compared to a pyramid, can have a higher surface area for chemical reaction with the spirit. The various shapes can also be modified such that the surface area of the wood piece is increased. For example, a face(s) or surface(s) of a wood piece can be notched, cut, scored, etc. to increase surface area that can be exposed to the spirit. One or more wood pieces of a first shape can be used with one or more wood pieces of a second different shape. The amount of surface area of different wood pieces can vary to provide different levels of interaction with a spirit. As such, a manufacturer can control or at least influence the enhancing process and create different flavor profiles as requested by the IBER. Various combinations of different shapes and different numbers of each shape can also be used in the same bottle. For example, a spire and a sphere can placed in the same bottle. The IBER can include the different shapes and the different numbers of each shape.

Instead of placing a spirit in a cask for enhancing, the disclosed method includes placing a spirit in a bottle and enhancing the flavor of the spirit in the bottle based on the IBER. Using the IBER allows a consumer to be part of the manufacturing process and create a manufactured enhanced spirit with their flavor profile. Using the IBER also increases the pool of creativity for developing new products.

An IBER can be received manually by a manufacturer. For example, a manufacturer may have a tasting room where consumers sample various spirit selections and the various options for enhancing the spirit. A consumer can simply submit an IBER, written or orally, to an attendant of the tasting room to initiate the manufacturing process.

The IBER can also be received via a computing device. The computing device can be owned or operated by the manufacturer, such as located in the tasting room, or can be another computing device, such as a consumer's, that is configured to receive an IBER. An application or computer program executing on the computing device can direct the computing device to receive the IBER and process the request. A user interface of the computing device, such as a keyboard, keypad, touchscreen, or microphone, can be used to receive or input the IBER. The computing device can include an IBER processor that is configured to generate a manufacturing order for a spirit or spirits based on the IBER. The IBER processor can be configured to automatically process the request by instructing the manufacturer to produce a certain number of bottles of a spirit, and place in the bottles the one or more products identified in the IBER. Additionally, the IBER processor can be configured to automatically determine the products and/or resting agents needed to obtain a flavor profile included in the IBER if needed. For example, the IBER processor can use a database of flavor profiles that include the products and resting agents needed to obtain the different flavor profiles. The IBER processor can select the products and resting agents needed from the database by interpolating between similar flavor profiles if there is not a match. The IBER processor can also use a learning algorithm to determine the needed products and resting agents for a requested flavor profile. As such, the IBER processor can use artificial intelligence to automatically select enhancers for a particular flavor profile. Enhancers are components placed in a bottle with a spirit, or used with the components that are placed in the bottle, to enhance the flavor of the spirit. Enhancers, for example, can be one or more products, such as a wood piece, and one or more resting agents, such as a different spirit than the bottled spirit. Enhancers can also be toast or char levels for the one or more wood pieces.

The IBER processor can also be used to comply with age requirements for the user. For example, government entities may require only users of a certain age can purchase alcohol products. As such, the IBER processor can be configured to at least inquire of the age of a user of the IBER and/or verify the age of the user is sufficient to meet requirements to purchase alcohol. The IBER processor can automatically inquire or verify the age of the user, i.e., originator of the IBER. The IBER processor may require a biometric input from the user that is validated before an order can be generated for a spirit. The IBER processor can communicate with another party or entity to verify the user is of sufficient age via the biometric input. More than one type of input may be required. For example, a finger print and voice ID may be needed. Besides, or in addition to, the IBER processor may request other forms of identification from the user, such as driver's license number or a credit card number, to verify user identification. A computing device, such as a mobile computing device, can include the necessary components to receive user identifications. For example, a camera of a smart phone can be used for an iris scan that is then compared to a database for verification of a user. Additionally, a touch pad or screen can be used to receive a user's fingerprint that is then compared to a database for verification.

The IBER processor can be located in a computing device, such as a mobile computing device, or located on a server. The IBER processor can be distributed, wherein functionality is located on one or more devices (such as a computing device and a server). As such, the IBER processor can be implemented on one or more processors or processing units. FIG. 2 illustrates an example of an IBER processor.

Turning now to the Figures, FIG. 1 illustrates a block diagram of an example of a computing system 100 configured to receive and process an IBER according to the principles of the disclosure. The computing system 100 includes a computing device 110, a server 120, and a communications network 130.

The computing device 110 is configured to communicate or interface with a user, such as a consumer, and receive an IBER for processing. The computing device 110 includes a user interface 111, memory (i.e., data storage) 113, a transceiver 115, and a processor 117. The computing device 110 can be a mobile communication device having mobile communication capability. The computing device 110 can be, for example, a smartphone, computing pad, tablet, laptop, or another portable computing device capable of communicating via the communications network 130. The computing device 110 can also be a desktop computer or another type of computer specifically configured to receive and process IBERs.

The computing device 110 can include additional components that are typically included in such devices. Each of the components of the computing device 110 can be coupled together via conventional connectors, busses, interfaces, etc. The user interface 111, data storage 113, transceiver 115, and processor 117 can be configured to operate as in a conventional device. Additionally, the computing device 110, can perform additional functions as disclosed herein, such as the features of the application 140 of FIG. 1A. The additional functions can be directed by an application, such as application 140, loaded on the data storage. Accordingly, at least some of the components of the computing device 110 are configured to cooperate to provide the additional functionality disclosed herein.

The user interface 111 is configured to receive an IBER. The user interface 111 can be or include a display, a microphone, a speaker, a keypad, a keyboard, another type of component that is used to interact with a user, or a combination of one or more these components. The user interface 111 can prompt the user for inputs and/or provide questions/prompts in response to a user input. Selections can be provided via the user interface 111 for the user to choose to create an IBER. The selections can be in a tabular form on a display, which the user can select. The selections can include products, resting agents, resting times, number of products, etc. to allow the user to create a flavor profile. A description of the different products and resting agents can also be provided. Drop down menus can also be used upon selecting a feature. For example, a wood piece can be selected as a product. Upon selecting the wood piece, another menu can be displayed that allows selecting the type of wood, toast level, char level, shape, etc. The user interface 111 can be driven by an application.

The computing device 110 can have an application stored thereon, such as in data storage 113, that is used to receive an IBER. The application can be a mobile application. For example, a smart phone configured (i.e., designed and constructed) for communication, can be employed to receive an IBER with the mobile application downloaded. In addition to receiving the IBER, the application can also initiate the manufacturing process. The application can initiate the manufacturing process by directing the processor 117. The application can also communicate the IBER to the server 120. As such, the processor 117 and/or the server 120 can include the necessary logic to process the IBER and initiate manufacturing. The computing device 110 can communicate with the server 120 via the transceiver 115 and the communications network 130. The computing device 110 can also download the application from the server 120 via the transceiver 115 and the communications network 130.

The transceiver 115 transmits and receives data over the communications network 130. The transceiver 115 can include a native chip set that processes the data for communicating, i.e., transmitting and receiving, such as for cellular communications or another communications network. As noted above the application can be received through the transceiver 115 and stored in the data storage 113. The data storage 113 can be a memory or memories, such as included in conventional computing devices.

The processor 117 can be configured (i.e., designed, constructed, or programmed) to provide at least a portion of the functionality of an IBER processor. As such, the processor 117 can generate a manufacturing order for a spirit or spirits based on the IBER. The processor 117, therefore, can include the necessary logic to convert the IBER into a manufacturing order. The processor 117 can determine the enhancers for a certain flavor profile identified in the IBER when the user requests a type of flavor as opposed to selecting enhancers, such as a product, resting agent, etc.

The server 120 includes conventional components or hardware typically included on a server that is configured to communicate via the communications network 130. The server 120 has a processor or processors that include hardware, software or a combination thereof to provide the necessary functionality of a server, such as a conventional server. The server 120 can include additional components that are typically included in a server, such as a power supply, communication interfaces, and a memory.

The server 120 is configured to store applications for download, such as to the computing device 110. The server 120 can also operate as the IBER processor. The server 120 includes a series of operating instructions stored on a local or built-in memory, or loaded during start-up into a memory associated therewith that direct the operation of the server 120 or processor thereof. The server 120 can include the necessary hardware and program code to provide a web interface for downloading the applications or receiving an IBER. The server 120 communicates with the computing device 110 via the communications network 130.

The communications network 130 is configured to communicatively couple the computing device 110 and the server 120. The communications network 130 can be wireless, wired, optical, or a combination thereof. The communications network 130 can include a combination of networks, such as a WLAN and the internet. A conventional network or cable can be used to connect the computing device 110 and the server 120 depending on the proximity between the two.

FIG. 1A illustrates a block diagram of an example of an application 140 providing functions according to the principles of the disclosure. The application 140 can be a computer program stored on a data storage of a computing device, such as the computing device of FIG. 1. The data storage can be a non-transitory computer readable medium. The application 140 can be a computer program product that is loaded, such as downloaded, on a mobile computing device. The application 140 can perform various functions according to operating instructions that represent an algorithm or algorithms. The functions directed by the algorithms include the features of the application 140 described below.

The application 140 has a payment feature 141 that can confirm payment has been made for various spirits, shipping costs, etc. The payment feature 141 can coordinate with an application store to confirm and make payments via the payment method used by a user with the application store. The payment feature 141 can also confirm a credit has been purchased for a user or provided as a gift for a user to create their own enhanced spirit.

Another feature provided by the application 140 is interacting with social media. For example, the application can include a social media interface 143 that works with various types of social media applications to allow posting of the enhanced spirit created by a user. The social media interface 143 can allow saving pictures associated with an IBER, such as pictures of a label, pictures of a sealed bottle, pictures of the enhancers or flavor profile from the IBER, etc. Posting via a social media application would be via the communications network and could incur data charges.

The application 140 can include an age monitor 145 that controls whether a user can order an alcoholic beverage based on their age. The age monitor 145 can coordinate receiving biometric information from a user and/or other information to verify the user is of sufficient age. The age monitor 145 can communicate with another service or application to verify the age of a user.

The application 140 can also include an interaction controller 147 that is configured to control interfacing with a user via one or more user interfaces. The interaction controller 147 can present visual forms to be filled out for the IBER and provide prompts/questions to assist in filling out an IBER. The interaction controller 147 can also communicate with a user to receive information to put on a label of the enhanced spirit. For example, an IBER can include a dedication to someone, or identify a certain company that provided the IBER (such as for gifts), etc. The interaction controller 147 can also work with user interfaces of the computing device to receive a signature of the user to put on the label. For example, a touch pad of a computing device can be used to receive a signature and added to a label.

The application 140 can also include a processor controller 148 and a communication controller 149. The processor controller 148 can direct operation of at least part of an IBER processor. The processor controller 148 can work with the IBER processor to generate an order based on the IBER. The communication controller 149 coordinates sending the order to a manufacturer. More than one manufacturer can receive IBER-based orders. For example, if the spirit is bourbon, the order can be sent to a bourbon manufacturer and if the spirit is rum, the order can be sent to a rum manufacturer. A single manufacturer can also be used to produce the enhanced spirits regardless of the spirit used in the bottle.

FIG. 2 illustrates a block diagram showing an example of a manufacturing system 200 constructed according to the principles of the disclosure. The manufacturing system 200 includes an IBER processor 210 and a manufacturer 220. The IBER processor 210 is configured to receive an IBER and generate an order for a spirit based on the IBER. The IBER processor 210 sends the IBER-based order to the manufacturer 220 for fulfilment. The logic of the IBER processor 210 to perform these functions can be located in a server, another computing device, such as a mobile computing device, or distributed in more than one device. The IBER processor 210 can be directed by a series of operating instructions that correspond to an algorithm or algorithms for performing the functions disclosed herein. The manufacturer 220 produces sealed bottles of a spirit (or even a combination of spirits) according to the IBER-based order. The sealed bottles can then be distributed or shipped in response to orders.

As noted above, the IBER processor 210 can use machine learning to determine enhancers needed to obtain a flavor profile, such as when a completed IBER does not include enhancers but does indicated a desired flavor profile. As such, the IBER processor 210 can include a neural network (NN) to provide analysis and direction on what enhancers to use to obtain a particular flavor profile. Accordingly, the IBER processor 210 can use learning algorithms as part of a learning system to determine how to obtain a flavor profile.

The IBER processor 210, or a portion thereof, can be one or more processing units, such as a graphics processing unit (GPU) or another parallel processor, a central processing unit (CPU) or another serial processor, or a combination of both. At least a portion of the IBER processor 210 can be located in a data center. The data center can provide the storage and networking needed to support neural network training, such as for the NNs disclosed herein.

The NNs disclosed herein include multiple layers of connected nodes that can be trained with input data to solve complex problems. For example, enhancers used to obtain flavor profiles can be used as input data for training of a NN. Once the NNs are trained, the NNs can be deployed and used to identify enhancers, such as products or resting agents, and classify objects or patterns in an inference process through which a NN extracts useful information from a given input. During training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset.

FIG. 3 illustrates a flow diagram of an embodiment of a method 300 of producing an enhanced spirit based on an IBER. The enhanced spirit can be a finished spirit, which is a distilled spirit that has been aged and then finished. The method 300 provides sealed bottles of the spirit that includes at least one product based on the IBER. The method 300 uniquely delivers reproducible flavor profiles according to an IBER. At least some of the steps of the method 300 can be performed by a manufacturer who is a commercial distributor of bottled spirits. Some of the steps can be performed by a user other than the manufacturer. An IBER processor can be used for some of the steps. Additionally, an application as disclosed herein can be used for one or more of the steps of method 300. The method 300 begins in a step 305.

In a step 310, an IBER is received. The IBER can be received, for example, by staff at a tasting room. The IBER can also be received via an application on a computing device. The IBER can identify enhancers for enhanced flavoring of a spirit (or spirits) and can identify the spirit. In some examples, the IBER can identify a flavor profile and an IBER processor can select enhancers needed to provide the flavor profile.

The spirit can be a distilled spirit obtained from a manufacturer as an already distilled product or can be produced via, for example, conventional methods. The distilled spirit can be a whisky, bourbon, rum, gin, tequila, etc. The distilled spirit can be aged. The distilled spirit can be aged by traditional methods such as placing it within wooden barrels for a designated amount of time. The amount of time can vary depending on the type of distilled spirit, different methods used (aging at sea, high altitudes, chemically controlled processes, etc.) or desired results. The spirit can be obtained as an aged distilled spirit. Additionally, the spirit obtained can be a non-distilled spirit.

An order is generated in a step 320 for producing a spirit and enhancing the spirit based on the IBER. The order can be automatically generated by an IBER processor based on the IBER. Generating the order can include verifying that the user submitting the IBER is of sufficient age to order or receive an alcoholic beverage. A computing device having an application directing at least part of an IBER processor can be used to generate the order. The IBER processor can determine the enhancers to add to the spirit in a bottle to achieve a flavor profile identified in the IBER. Accordingly, the order can identify the spirit or spirits and enhancers for a flavor profile of the IBER; one or more products, and/or resting agents. The spirit can be a fermented spirit, a distilled spirit, or a fortified spirit. The distilled spirit can be an aged, distilled spirit.

Using a wood piece as an example, the type of wood piece selected corresponds to a particular taste profile that is desired according to the IBER. Several different flavor factors can be selected to obtain a particular flavor profile. The taste profiles can vary by the type of wood of the wood piece and the amount of “toast or char” to which the wood is exposed. The types of wood include, but are not limited to, American oak, French oak, Cherry, Apple, Ash, and Mesquite. The wood piece can be cut from wood barrels that were previously used for aging of a distilled spirit or a spirit, such as wine, or beer. The wood piece can also be cut from wood barrels that were previously used for storing non-alcoholic products or liquids, such as tea, coffee, soft drinks, etc. The wood piece can also be selected from a type of wood that has not been actually used as part of a barrel but is the type of wood that is typically used in one of the barrels.

Toast levels are typically used to represent the amount of toast for the wood piece and are the degrees of heat to which the wood is exposed. The heat applied to the wood or wood piece molecularly changes the wood, causing it to release certain botanicals that are inherent in the wood. In some embodiments, the different toast levels are Light toast, Medium toast, and Heavy toast. The toast levels can correspond to industry standards.

Charring is a chemical process of incomplete combustion of the wood when subjected to high heat. Char levels are the degrees to which the wood or wood piece is exposed to fire. Like toasting, charring wood causes the wood to release different botanicals and flavor essences. Different Char levels is the time or duration that the wood is exposed to fire. In one embodiment, the charring or Char levels that are used include Char 1, Char 2, and Char 3. The Char levels can correspond to industry standards.

A manufacturer can mix and match the wood type, toast levels, and char levels to obtain different flavor profiles according to the IBER. The manufacturer can also use more than one wood piece and the multiple wood pieces can have a different one of one or more of a wood type, toast level, or char level according to the IBER. For example, one wood piece can be a medium toasted American oak with a char level of 1, and a second wood piece can be light toasted ash with a char level of 2. A combination of different shapes of wood pieces can also be used by the manufacturer according to the IBER. The surface area for the one or more of the different wood pieces can also be different to allow different influences on the spirit from the different wood pieces. Each of the various types of wood pieces can be constructed to provide reproducible flavor profiles. For example, by employing standard toast and char levels, a manufacturer can create and deliver reproducible flavor profiles to consumers employing in-bottle finishing. Employing a standard design, e.g., same dimensions and surface area, for the wood pieces also assists in delivering reproducible flavor profiles. For example, as noted above the wood pieces can be wood spires. To ensure the delivery of a consistent flavor profile the wood spires can be consistently cut a certain way. In some embodiments, the wood spires can be 5 inches in length (127 mm), ⅝ inches in diameter (15.875 mm), and cut in a spiral shape to expose more wood surface area. Similar construction consistency can be used for the other examples of wood pieces, also. For examples, spheres, cubes, etc. can be reproducibly constructed.

The wood pieces can be cut to provide a desired ratio of the surface area to spirit volume within a bottle. Considering again a wood spire as an example, the surface area to volume ratio can be 467 mm² to 750 ml. Wood spires of different dimensions can be used for different sized bottles such that there is a consistent ratio of the wood surface area to the volume of spirits regardless the bottle size. In some embodiments, the surface area of the wood relative to the volume of spirit is precisely determined to finish the spirit “in-bottle” within a designated amount of time. Using a 750 ml bottle, the surface area to volume ratio can be the aforementioned 467 mm to 750 ml for an in-bottle finishing of six weeks. As noted above, the desired ratio of the surface area to spirit volume within a bottle can vary with different wood pieces in the same bottle; this can also affect the resting of a wood piece.

In addition to the wood type, toast level, and char level, the wood pieces can also be rested to obtain specific flavor profiles based on the IBER. Before a wood piece is placed in the bottle of a spirit, depending on the taste profile that is desired from the IBER, the wood piece, which can also be toasted or charred, may rest in a separate spirit, such as rum, brandy, wine or beer, to add yet another level of complexity to the final finished spirit. Instead of a spirit, the wood piece can rest in a non-alcoholic product before being place in the bottle. For example, the wood piece can be rested in one or more of coffee, tea, a soft drink, honey, syrup, or another type of non-alcoholic liquid. The wood piece can also be rested in products that are not liquids (i.e., non-liquids), such as cinnamon, nutmeg, allspice, anise, vanilla, mint, or other types of spices. Floral products can also be used, including clover, hibiscus, honeysuckle, lavender, roses, etc. Fruit products, such as apple, orange or another type of citrus, or peach, is another example of non-liquid products that can be used for resting. The non-liquid products can be mixed with water or another type of liquid to create a liquid that can be used for the resting of the wood piece. The different type of liquids or non-liquids used for resting are collectively referred to as resting agents. One or more wood pieces can each be rested in different resting agents before being placed in the bottle. For example, a first spire can be rested in wine and a second spire can be rested in honey and both the first spire and the second spire can then be placed in the same bottle. Wood pieces of a particular shape can be rested in the same resting agent. For example, cubes can be rested in hibiscus and spheres can be rested in lavender. In some examples, the resting can produce wood pieces of different colors depending on, for example, the type of wood and the resting agent. For example, the spheres rested in lavender can have a purple color that is visible in a bottle of gin. The IBER can include a request for different colors.

The amount of resting time can vary depending on empirical data for desired flavor profiles. At some point, absorption can be at least substantially reached where additional resting for a wood piece is not or only negligibly beneficial. The amount of resting time for the wood pieces can be six weeks and can vary depending on the type of wood piece and the resting agent. The IBER can include the amount of resting time.

The spirit based on the IBER is placed in bottles in a step 330. A conventional method of bottling according to the industry may be employed to place the spirit in bottles. As such, the bottles can be filled with the spirit according to industry standards. The bottles are the containers used for distributing the end product of the method 300. For example, the bottles in step 330 are the bottles that will later be sealed by the manufacturer, distributed, and sent to the users submitting the IBER. The sealed bottles can also be shipped and placed on shelves for purchase by other end users. Typically, the bottles are constructed of glass and have a sufficient opening to receive a product, such as a wood piece, as disclosed herein. The IBER can identify more than one spirit and the multiple spirits can be placed in the bottles.

One or more products are placed in the bottle having the spirit in a step 340. The one or more products correspond to the IBER. Continuing with the example of the product being a wood piece, after selection of the wood piece, the type of selected wood piece is placed in each of the bottles by the manufacturer according to the IBER. The wood pieces can be placed in the bottles by hand. In some embodiments, multiple of a single type of the wood pieces can be placed in the bottles as long as a consistent reproducible finishing can be performed. For example, a known or desired surface area to volume ratio of wood to spirit can be maintained. A different type of wood piece can be placed in different bottles. For example, a French Oak wood piece can be placed in some bottles and a charred oak wood piece can be placed in other bottles. Different wood types of wood pieces can be placed in a single bottle for a mixture of finishing woods according to the IBER. Additionally, multiple wood pieces of the same wood type can be placed in bottles. Wood pieces of different shapes, wood types, char levels, toast level, resting agent, and any combination thereof can be placed in the same bottle based on the IBER.

In a step 350, the bottles having the spirit and the one or more products, are sealed. The bottles can be sealed via conventional procedures typically employed in the alcohol beverage industry. The manufacturer seals the bottles with the one or more product inside. Thus, the method 300 produces sealed bottles of spirit having at least one product designed/cut/manufactured/processed for a selected flavor profile according to an IBER.

A label is added to the bottles in a step 360. The manufacturer can attach labels to the bottles employing conventional methods known in the industry. Each of the labels can correspond to the type or types of wood pieces that is used for the enhancing according to the IBER. For example, a bottle can include bourbon and a wood piece that is toasted American oak based on the IBER. Accordingly, the label can include bourbon and note a toasted oak finish from an American oak wood piece, such as a spire. When the wood piece is rested in a resting agent, the label can also note the contribution of the resting to the flavor profile noted on the label. For example, when the wood piece is rested in tea, the label can list the type of wood piece and indicate that the wood piece was rested in tea. The label can also indicate the type of tea and/or brewing process of the tea used for resting, such as cold brew versus hot brew. When multiple wood pieces are in the bottle, the label can note the contribution of the combination of flavors. Thus, a user can know the type of in-bottle enhancing that is used with each bottle and compare to the submitted IBER. The label can also include a signature of the creator or originator of the IBER.

The sealed bottles with at least one product are rested in a step 370. The bottle resting can be for a designated amount of time according to, for example, the IBER. The amount of time for bottle resting can also be determined by the manufacturer separate from the IBER. Using a wood piece as an example of a product, the amount of time can be based on empirical data and usually corresponds to the exhaustion or substantial exhaustion of a wood piece or pieces within the bottle. A wood piece is exhausted when it has imparted all or substantially all of the flavor that it can or is intended to impart to the surrounding spirit. Typically the designated amount of time for resting or finishing is not changed to ensure consistent enhancing through multiple batches of production. The time for the enhancing, such as in-bottle finishing, corresponds to the completion of the exchange of chemical constituents between the wood piece and the bottled spirit. As such, the enhancing process, such as in-bottle finishing, disclosed herein is a function of the wood piece (design, size, production, type, toast, char, resting agent, etc.), liquid volume, and amount of time the sealed bottle is rested. The values of the variables of the enhancing process can be changed to provide the contribution of organic compounds to transform acids into esters to give the bottled spirits the desired unique flavor. In some embodiments, a taste test is used to determine a desired product taste and the combination and values of the variables used to provide the desired product taste are selected for manufacturing and consistent reproduction of the enhanced spirit.

Considering the wood spired discussed above as an example, once the spire is placed in-bottle, the bottle can be rested for six weeks before it is distributed or sold for consumption to allow sufficient time for the wood spire to enhance (sanctify) the spirit. As the finished product ages beyond six weeks, the flavor profiles typically will not change, but the product can become smoother and less harsh. A time for shipping and distributing can be considered in the total time for resting or finishing.

In a step 380, the sealed bottles with at least one or more product according to the IBER are shipped. At this point, the manufacturer has completed the production process according to the IBER and the spirit is ready to be distributed and enjoyed by the user submitting the IBER or others. An address or addresses for shipping the sealed bottles can be included in the IBER. The method 300 ends in a step 390. One skilled in the art will understand that at least some of the steps of the method 300 can be performed in a different order than disclosed herein. For example, bottles can be labeled before adding the spirit and/or the one or more product.

FIG. 4 illustrates a flow diagram of an embodiment of a method 400 of producing an enhanced spirit based on an IBER. The enhanced spirit can be a finished spirit, which is a distilled spirit that has been aged and then finished. The method 400 provides sealed bottles of the spirit that includes at least one wood piece according to the IBER. The method 400 uniquely delivers reproducible flavor profiles employing an in-bottle wood piece or wood pieces based on the IBER. At least some of the steps of the method 400 can be performed by a manufacturer, who is a commercial distributor of bottled spirits, according to instructions/request from an IBER. Some of the steps can be performed by a user other than the manufacturer. An IBER processor can be used for some of the steps. Additionally, an application as disclosed herein can be used for one or more of the steps of method 400. The method 400 begins in a step 401.

In a step 405, an order for manufacturing a spirit based on an IBER is generated. The order can include the type of spirit and one or more wood pieces to include in bottles with the spirit. In some examples, more than one spirit can be placed in a bottle according to the IBER.

In a step 410, a spirit is obtained according to the order. The spirit can be a fermented spirit, a distilled spirit, or a fortified spirit. The distilled spirit can be an aged, distilled spirit. The spirit or spirits can be obtained from one or more manufacturers.

The spirit is placed in bottles in a step 420. A conventional method of bottling according to the industry may be employed to place the spirit in bottles. As such, the bottles can be filled with the spirit according to industry standards. The bottles are the containers used for distributing the end product of the method 400. For example, the bottles in step 420 are the bottles that will later be sealed by the manufacturer, shipped to users, and may be placed on shelves for purchase. Typically, the bottles are constructed of glass and have a sufficient opening to receive a wood piece as disclosed herein. Different bottles can be used for different wood pieces.

In a step 430, one or more wood pieces are selected based on the IBER. The type of wood pieces selected can be identified in the IBER or correspond to a particular taste profile noted in the IBER. The IBER may identify the type of wood and an IBER processor or the manufacturer can select the wood shape. One or more wood pieces corresponding to several different flavor factors can be selected to obtain a particular flavor profile. The taste profiles can vary by the type of wood of the wood piece as discussed above.

The IBER can select one or more wood pieces that are the same or can mix and match the wood pieces to obtain different flavor profiles. The one or more wood pieces can have a different one of one or more of a wood type, toast level, char level, shape, surface area, etc. As such, a combination of different shapes of wood pieces can be used by the manufacturer according to the IBER and the surface area for the different wood pieces can also be different to allow different influences on the spirit in the bottle from the different wood pieces. Each of the various types of wood pieces can be constructed to provide reproducible flavor profiles in multiple bottles. As noted above, the desired ratio of the surface area to spirit volume within a bottle can vary with different wood pieces in the same bottle; this can also affect the resting of a wood piece. The one or more wood pieces can be infusion spirals commercially available from, for example, The Barrel Mill in Central Minnesota.

In step 440, one or more of the wood pieces are rested in a resting agent according to the IBER. Each of the one or more selected wood pieces can be rested in a different resting agent or agents or the same resting agent. As noted above, the resting agent can be a type of spirit or non-alcoholic. A wood piece can be rested in a first resting agent and then rested in one or more other resting agents. Additionally, different products can be combined to provide a resting agent. For example, a spirit can be combined with a non-spirit and the wood piece rested in the combination. Wood pieces of a particular shape can be rested in the same resting agent and can be used to add color to the wood pieces. The amount of resting time can vary due to the wood piece (e.g., shape, size, surface area) and resting agent. The resting of the wood pieces can be performed by another party instead of the manufacturer. Accordingly, the manufacturer can select wood pieces in step 430 that have already been rested according to the IBER. The manufacturer can also perform additional resting in the same or another resting agent.

The one or more wood pieces are placed in each of the bottles by the manufacturer in a step 450. The wood pieces can be placed in the bottles by hand or machinery can be used. Wood pieces of different shapes, wood types, char levels, toast levels, resting agents, and any combination thereof can be placed in the same bottle according to the IBER.

In a step 460, the bottles having the spirit and the one or more wood pieces are sealed. The bottles can be sealed via conventional procedures typically employed in the alcohol beverage industry. The manufacturer seals the bottles with the one or more wood pieces inside. Thus, the method 400 produces sealed bottles of spirit having at least one wood piece designed/cut/manufactured/processed for a selected flavor profile according to the IBER.

A label is added to the bottles in a step 470. The manufacturer can attach labels to the bottles employing conventional methods known in the industry. The label corresponds to the IBER. The label can include a signature of the user of the IBER and/or other information the user desires to place on the label.

In a step 480, the bottles with the spirit and at least one or more wood piece according to the IBER are shipped. The sealed bottles can be shipped to an address or addresses identified by the user submitting the IBER. At this point, the manufacturer has completed the production process based on the IBER and the spirit is ready to be distributed to the user. The sealed bottles can be rested before being shipped. The method 400 ends in a step 490. One skilled in the art will understand that at least some of the steps of the method 400 can be performed in a different order than disclosed herein. For example, the wood pieces can be selected before adding the spirit to the bottles and/or the one or more wood pieces can be added to the bottles before adding the spirit. Additionally, instead of a single spirit, multiple spirits can be identified by the IBER or a flavor profile of the IBER.

FIG. 5 illustrates an example of a bottle 500 of spirit having wood pieces for enhancing that has been manufactured using an IBER. The bottle 500 includes a body 510, a lid 520, a seal 530, a spirit 540, a label 550 and wood pieces 560. The spirit 540 and the wood pieces 560 are within a volume defined by the body 510. The bottle 500 can include more than one spirit according to the IBER. The bottle 500 is constructed of a non-permeable material, such as glass, and is ready for commercial sale. Thus, the bottle 500 is ready to be shipped or placed on shelves for purchase by consumers.

The body 510 defines the shape and volume of the bottle 500. The body 510 has an inner and outer surface. The body 510 is an example that collectively represents the base, heel, shoulder, etc., and other known parts of a bottle. The lid 520 is used to cover the orifice of the bottle 500. The lid 520 can be cork, a screw cap, or another type of lid that is conventionally used. The seal 530 is used to secure the lid 520 and indicate no tampering from the manufacturer to the consumer. Conventional types of seals can be used. As illustrated, the bottle 500 is sealed after the wood pieces 560 are placed in the bottle 500. Since the bottle 500 is for commercial sale, the seal 530 is unbroken in FIG. 5. Other types of seals and lids can be used than the illustrated examples.

The wood pieces 560 represent one or more products selected by an IBER. The wood pieces 560 are placed in the bottle 500 before the lid 520 and the seal 530 are placed thereon. The wood pieces 560 include a pyramid 562, a cube 563, and spheres 565, 567, and 569. One of more of the wood pieces 560 can be different types of woods, with different toast levels, char levels, or neither no toast nor char. The surface area of one or more of the wood pieces 560 can also be different. One or more of the wood pieces 560 can also be rested wood pieces that have rested in a resting agent or agents before being placed in the bottle 500. The one or more wood pieces 560 can be rested according to comply with the IBER. A combination of the wood pieces 560 rested in different resting agents can be used. For example, the pyramid 561 can be rested in a first resting agent and the cube 563 can be rested in different resting agent. One or more of the spheres 565, 567, 569, can be rested in one of the same resting agents or yet in a third resting agent. Each of the spheres 565, 567, 569, can be rested in the same resting agent. The different wood pieces 560 can inherent a color from their resting agent that can provide a pleasing visual presentation in the bottle 500 along with the functional enhancing of the spirit 540. The wood pieces 560 can have other shapes than those shown in FIG. 5 and the number of wood pieces can vary based on the IBER. As disclosed herein, the wood pieces 560 can be designed to correspond to the volume of the bottle 500 and a desired time for enhancing the spirit. When first placed in the bottle 500 with the spirit 540, the wood pieces 560 will float. The wood pieces 560 absorb the spirit 540 during the process of exchanging chemical constituents with the spirit 540 and sink to the bottom of the bottle 500. In FIG. 5, the wood pieces 560 are saturated with the spirit 540 and have sunk to the base of the bottle 500.

The label 550 corresponds to the type of wood pieces 560 within the bottle 500 and corresponds to the IBER. The label 550 can include the name and/or signature of the user who submitted the IBER. The label 550 can be attached to the bottle 500 via a conventional procedure. The body 510 can include an indentation area (not identified in FIG. 5) that corresponds to a shape and size of the label 550 and the label 550 can be placed within the indentation section. The bottle 500 with lid 520, seal 530, spirit 540, label 550 and wood pieces 560, can be shipped for commercial distribution and sale. When one or more of the wood pieces are rested, the label 550 reflects the contribution of the resting to the flavor profile according to the IBER.

A portion of the above-described apparatus, systems or methods may be embodied in or performed by various digital data processors, wherein the processors are programmed or store executable programs of sequences of software instructions to perform one or more of the steps of the methods. A processor may be, for example, a programmable logic device such as a programmable array logic (PAL), a generic array logic (GAL), a field programmable gate arrays (FPGA), or another type of computer processing device (CPD). The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory signals, such as propagating signals and carrier signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

It is noted that as used herein and in the appended claims, the singular forms “a”, “an”, and “the” include plural referents unless the context clearly dictates otherwise.

Those skilled in the art to which this application relates will appreciate that other and further additions, deletions, substitutions and modifications may be made to the described embodiments. For example, in-bottle enhancing using one or more products according to an IBER, such as a wood piece, can include spirits that are distilled or not distilled, different aging times, and different product to volume ratios. This disclosure can also apply to imparting a flavor from a wood piece or another type of flavor provider in a bottle, of other types of liquids, that is produced for sale according to an IBER as provided herein.

What is claimed is:

1. A method of manufacturing an enhanced spirit, comprising:
receiving an in-bottle enhancement request (IBER);
placing at least one spirit in a bottle based on the IBER;
placing one or more products in the bottle based on the IBER; and
sealing the bottle, having located within the bottle both the at least one spirit and the one or more products.

2. The method as recited in claim 1, wherein the IBER includes the one or more products, one or more resting agents, or a combination of one or more products and one or more resting agents.

3. The method as recited in claim 1, further comprising processing the one or more products according to the IBER.

4. The method as recited in claim 1, wherein the IBER includes a description of a desired enhanced flavor for the spirit and the method further includes selecting the one or more products based on the description.

5. The method as recited in claim 1, wherein the IBER identifies a flavor profile and the method further includes automatically selecting enhancers to achieve the flavor profile, wherein the enhancers include the one or more products.

6. The method as recited in claim 5, wherein the automatically selecting enhancers uses machine learning.

7. The method as recited in claim 1, wherein the receiving is via an application on a computing device.

8. The method as recited in claim 1, further comprising automatically generating an order for the enhanced spirit based on the IBER.

9. The method as recited in claim 1, further comprising placing a label on the bottle, wherein the label corresponds to a flavor profile associated with the IBER and includes a signature of an originator of the IBER.

10. The method as recited in claim 1, further comprising shipping the sealed bottle to an address included on the IBER.

11. A computing system for receiving and processing an in-bottle enhancement request (IBER) for an enhanced spirit, comprising:
one or more processors to perform one or more operations including:
receiving an IBER;
determining one or more enhancers for a spirit based on the IBER; and
automatically generating an order for one of more bottles of an enhanced spirit using the one or more enhancers.

12. The computing system as recited in claim 11, wherein the determining includes automatically selecting one or more products according to a description of a flavor profile from the IBER.

13. The computing system as recited in claim 11, wherein the automatically selecting uses a machine learning algorithm.

14. The computing system as recited in claim 11, wherein the determining includes using one or more products identified on the IBER.

15. The computing system as recited in claim 11, wherein the determining includes selecting one or more products according to a description of a flavor profile from the IBER.

16. The computing system as recited in claim 11, wherein the receiving is via an application that prompts an originator of the IBER for inputs to generate the IBER, wherein at least some of the prompts are in response to one or more of the inputs.

17. The computing system as recited in claim 11, further comprising receiving a signature of an originator of the IBER and including the signature with the order for placing on a label of the one or more bottles of the enhanced spirit.

18. A computer program product having a series of operating instructions stored on a non-transitory computer-readable medium that directs one or more processors when executed thereby to perform operations to generate an order for an enhanced spirit, the operations comprising:
receiving an IBER;
determining one or more enhancers for a spirit based on the IBER; and
automatically generating an order for one of more bottles of an enhanced spirit using the one or more enhancers.

19. The computer program product as recited in claim 18, wherein the IBER includes a selection of enhancers that include one or more products and at least one resting agent for at least one of the one or more products.

20. The computer program product as recited in claim 18, wherein the operations further include determining an originator of the IBER satisfies an age requirement for purchase of alcohol products.
